(19) United States
(12) Patent Application Publication
(10) Pub. No.: US 2026/0339622 A1
(43) Pub. Date: Oct. 29, 2026

(54) CODE GENERATION WITH INTENTION TREES

(71) Applicant: INTERNATIONAL BUSINESS MACHINES CORPORATION, Armonk, NY (US)

(72) Inventors: Lucia Larise Stavarache, Columbus, OH (US); Kyle Gene Brown, Apex, NC (US); Gennaro Anthony Cuomo, Raleigh, NC (US); Yu Cai, Beijing (CN); Stephen Meier, Raleigh, NC (US); TADAS DANIELIUS, Vilnius (LT)

(21) Appl. No.: 19/188,678

(22) Filed: Apr. 24, 2025

(51) Int. Cl. G06F 8/35; G06F 8/41

(52) U.S. Cl. CPC G06F 8/35; G06F 8/427

(57) ABSTRACT

Methods and systems for code generation include generating a syntax tree from an original code base to represent syntactical information of the original code base. The syntax tree is converted to a cladogram. An intention tree is generated using the cladogram to represent the syntactical information associated with intention statements that describe an intention associated with portions of the original code base. Code is generated in accordance with the intention tree.

### BACKGROUND

The present invention generally relates to automated programming code generation and, more particularly, to the use of intention trees to represent user intention.

Large language models (LLMs) use a transformer-based architecture to generate programming code. These models are pre-trained on a large dataset that includes natural language as well as various programming languages. The LLM learns to predict the next code in a sequence, which helps to capture the syntax and semantics of the code. During code generation, the LLM uses a prompt that defines the coding task to guide its output, thereby ensuring that the code is syntactically correct and contextually relevant.

However, such models are trained using a volume approach, which overlooks nuances of the surrounding code, its inner-code intentions, and how the code fits into a larger body. This limitation makes it difficult for LLMs to stay close to the intention of the user.

### SUMMARY

A method for code generation includes generating a syntax tree from an original code base to represent syntactical information of the original code base. The syntax tree is converted to a cladogram. An intention tree is generated using the cladogram to represent the syntactical information associated with intention statements that describe an intention associated with portions of the original code base. Code is generated in accordance with the intention tree.

A computer program product includes one or more computer-readable storage media and program instructions stored on the one or more computer-readable storage media to perform operations. The operations include generating a syntax tree from an original code base to represent syntactical information of the original code base, converting the syntax tree to a cladogram, generating an intention tree using the cladogram to represent the syntactical information associated with intention statements that describe an intention associated with portions of the original code base, and generating code in accordance with the intention tree.

A computer system includes a processor set, one or more computer-readable storage media, and program instructions stored on the one or more computer-readable storage media to cause the processor set to perform operations. The operations include generating a syntax tree from an original code base to represent syntactical information of the original code base, converting the syntax tree to a cladogram, generating an intention tree using the cladogram to represent the syntactical information associated with intention statements that describe an intention associated with portions of the original code base, and generating code in accordance with the intention tree.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram illustrating the use of an intention tree in manipulating code with a large language model (LLM), in accordance with an embodiment of the present invention;

FIG. 2 is a block/flow diagram of a method for generating an intention tree from an original code base, in accordance with an embodiment of the present invention;

FIG. 3 is a diagram illustrating the conversion of a project component into an intention tree, in accordance with an embodiment of the present invention;

FIG. 4 is a block/flow diagram of a method for using an intention tree to manage code, in accordance with an embodiment of the present invention;

FIG. 5 is a block/flow diagram of a method for creating an intention tree, in accordance with an embodiment of the present invention;

FIG. 6 is a block diagram of a computing environment that can perform intention tree generation and analysis, in accordance with an embodiment of the present invention;

FIG. 7 is a diagram of an exemplary neural network architecture that can be used to implement part of a large language model, in accordance with an embodiment of the present invention; and

FIG. 8 is a diagram of an exemplary deep neural network architecture that can be used to implement part of a large language model, in accordance with an embodiment of the present invention.

### DETAILED DESCRIPTION

Intention trees can be used to enhance automated programming code generation, capturing the cladistic relationship between the code and the user's intention. Cladistic analysis looks to relationships among entities to reconstruct trees that show how those entities evolve over time. Cladistics relationships and bi-directional intention can be used to decompose programming code's functional capabilities and intention, so that they can be reconstructed in a natural order.

Intention may be captured as a natural language explanation of an individual code block, which may be understood as the smallest denomination of code in a given language. Examples of a code block may be a function, function in function, function in class, or class. The code block can be formed from a function to a full class. Intention trees help guide a large language model (LLM) to align the functionality desired in the programming code output with the user's intentions. Duplicated code is avoided, because the LLM is augmented with an understanding of the overall code and project structure.

An intention tree may be defined with differing levels of granularity. For example, a high-level intention may be expressed for an entire class, with individual methods and data structures having their own lower-level intentions. This can continue to the level of individual lines or have functions as a minimum denominator.

The intention information may be particularly useful in automatically refactoring code, where recognizing the intention of a particular block of code can be used to prevent duplication. The intention information can also be used to help identify the origin of particular blocks of code.

According to an aspect of the invention, there is provided method for code generation includes generating a syntax tree from an original code base to represent syntactical information of the original code base. The syntax tree is converted to a cladogram. An intention tree is generated using the cladogram to represent the syntactical information associated with intention statements that describe an intention associated with portions of the original code base. Code is generated in accordance with the intention tree. The use of an intention tree ensures that the intent of the original code base is preserved, which can help reduce redundancy and drift.

In some embodiments, generating the intention tree includes intention statements at a per-line granularity. Selection of a per-line granularity ensures that the intention of each piece of code can be captured separately.

In some embodiments, generating the intention tree includes intention statements at a per-function granularity. Selection of a per-function granularity reduces the complexity of the intention tree and captures high-level similarities across portions of the code.

In some embodiments, converting the syntax tree to the cladogram includes adding syntax nodes that represent code from the original code base and intention nodes that represent intentions of the syntax nodes, with edges between the intention nodes and respective syntax nodes. The extension of the cladogram to include intention information captures the intent of the program code in a manner that can be manipulated by a language model.

In some embodiments, the original code base includes multiple versions of a given program component. The multiple versions of the program component can help show how the program component changes over time.

In some embodiments, edges are added between nodes corresponding to the multiple versions in the graph. This captures the cladistic relationship between nodes.

In some embodiments, edges are added between nodes describing similar intentions in the graph. This makes it possible to cluster related code so that redundancy can be reduced when refactoring the original code base.

In some embodiments, generating the code includes refactoring the original code base to remove redundancy. This can help to reduce the size of the code base and simplify it.

In some embodiments, nodes of the intention tree with similar intentions are clustered to identify redundant code. The similarity between intentions shows that code is written to achieve similar purposes, so that the code base may be refactored by condensing such code portions.

In some embodiments, generating the intention tree includes querying a large language model to generate the intention statements for respective portions of the original code base. This makes it possible to automatically identify the intentions of portions of the code without detailed human oversight.

Referring now to FIG. 1, an example of code generation with intention trees is shown. An LLM 104 processes a query 102. The query 102 may include natural language instructions that describe the desired functions of a program code output 106. The LLM 104 operates to generate program code 106 that is syntactically correct within a given programming language and that is furthermore semantically correct, in that it performs a function according to the user's intention.

To help the LLM 104 generate better program code 106 that stays close to the user's intention, the LLM 104 further accepts an intention tree 108 as an input. The intention tree 108 provides a representation of the user's intention that supplements the natural language instructions of the query 102.

The intention tree 108 may combine concepts of code in a syntax tree form with user intention as well as cladistics relationships between the code and its intention. The intention tree 108 can be used to align the functionality of new program code 106 with the intention of existing programming code. Next token generation by the LLM 104 is furthermore improved by aligning the next token with user intentions. The intention tree 108 can also be used to prompt the LLM 104 to suggest refactoring existing code to better align with the user's intention.

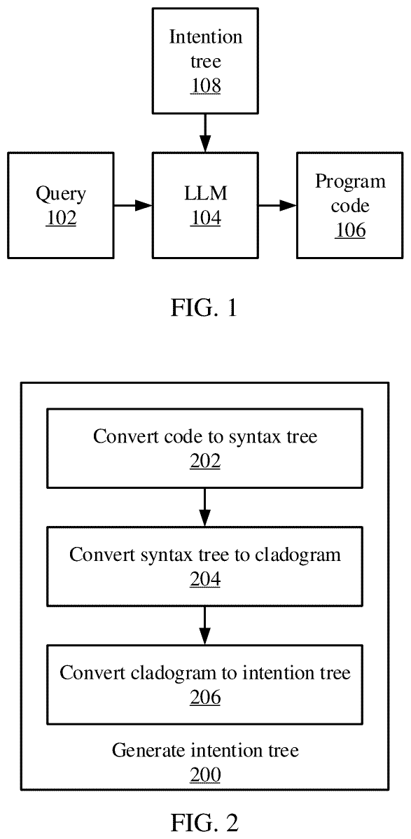

Referring now to FIG. 2, a method for generating an intention tree 200 is shown. Block 202 uses existing program code to produce a syntax tree. A syntax tree is represents the structure of program code as a tree data structure, with nodes representing some element of the source code text. The edges in the tree establish structural relationships between the nodes. For example, a given operator that takes two inputs may be represented as a sub-tree that includes a parent node that defines the operator and two child nodes that define the respective input variables. The representation of an input segment of program code can be losslessly translated into a syntax tree, such that the original source code can be substantially reproduced from the syntax tree.

Block 202 may process a corpus of existing program code to generate one or more syntax trees. For example, a repository of program code relating to a given application may be used to generate trees that represent the syntax for the entire application. In some cases, program code for multiple different applications may be processed together.

Block 204 then converts the syntax tree(s) to a cladogram. The cladogram provides a hierarchical abstraction that transitions to a representation focused on intent, which provides a semantic layer above syntax. Block 204 may employ a cladistic analysis, where “characters” are understood as distinct features of algorithms that can vary independently. Examples of characters include recursion, iteration, data structure types such as arrays and linked lists, and error-handling strategies. Each feature is coded as being present, absent, or in multiple discrete states to represent programming solutions and algorithms. Sorting algorithms, for example, may be coded for features like “recursion,” “stability,” “adaptiveness,” and “in-place operation.”

Using the cladogram, intent may be inferred from the cladogram to create the intention tree in block 206, thereby providing a hybrid, interpretable system for intent detection. The cladogram is analyzed to uncover relationships between the algorithms, potentially revealing evolutionary developments in data structures and error-handling strategies. The intention trees represent both the syntax and intentions between different parts of an algorithm, providing insights into performance optimizations, memory usage, and readability. The character coding may be performed with a matrix, where rows represent different algorithms and where columns represent features. Each cell of the matrix is coded based on whether the algorithm has the feature as indicated in its intention tree. The intention tree may be constructed using, for example, a maximum parsimony approach or a maximum likelihood approach, to build a cladogram that groups algorithms based on shared derived features, showing how algorithms relate to one another based on their characteristics.

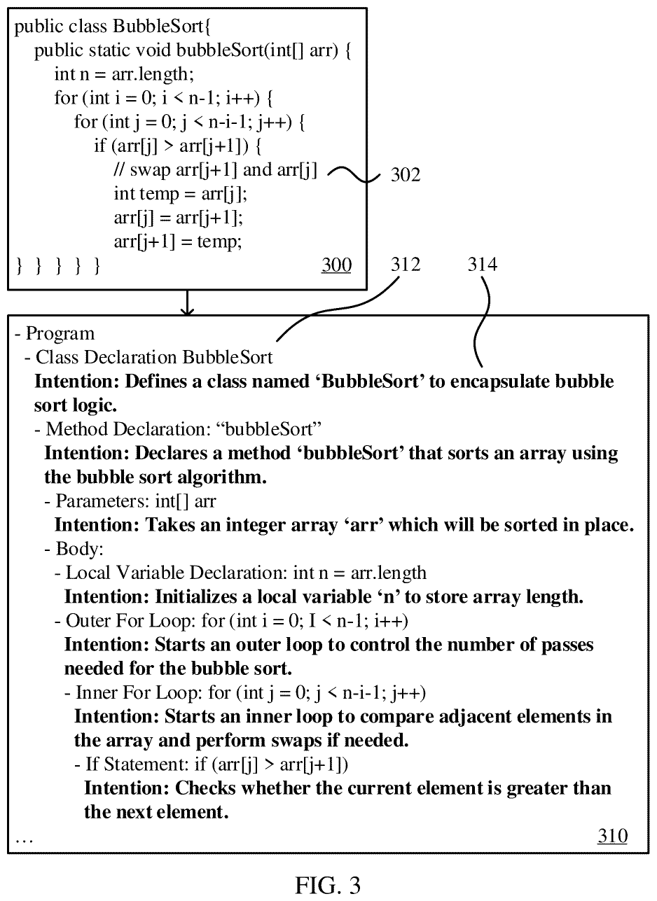

Referring now to FIG. 3, generation of an intention tree is illustrated. An original source code segment 300 is processed to generate intention tree 310. The original code 300 includes a series of original statements 302 written according to the syntax of a particular programming language.

These original statements 302 may be converted to a series of syntax statements 312 in the intention tree, which are paired with intention statements 314. The syntax statements 312 identify the syntax of corresponding original statements 302, for example describing what each statement does according to the programming language being used. The corresponding intention statements 314 provide a natural language description of the original statements 302. In some cases, the intention statements 314 may be generated automatically, for example by providing a cladogram to the LLM 104 with a prompt that instructs the LLM 104 to describe the original statements 302.

Although the intention tree 310 is shown with a line-by-line description of the original source code segment 300, other granularities may be used instead. For example, intention statements 314 may instead be generated for entire functions or any other appropriate level of abstraction.

In addition to intention statements, the intention tree 310 may include characteristics statements, which associate features with particular original statements 302. Following the example of FIG. 3, the class declaration may instead be described with an intention statement and a characteristics statement. For example, “Intention: Defines a class named ‘BubbleSort’” and, “Characteristics: Contextual Scope: Encapsulates bubble sort method within a class.”

The cladogram can be used to illustrate how a set of algorithms are conceptually related, providing insights into the evolution of these algorithms over time, for example in response to changing hardware capabilities or new types of applications that need different performance considerations. In one example, intention trees can be created for a variety of sorting algorithms, such as bubble sort, merge sort, quick sort, and insertion sort. Characteristics of these sorting algorithms might include recursion (present in merge sort and quick sort, but absent in bubble sort and insertion sort), in-place sorting (present in bubble sort, quick sort, and insertion sort, but absent in merge sort), stability (present in bubble sort and merge sort, but potentially absent in quick sort without modifications), and complexity (e.g., logarithmic, linear, quadratic, etc.). The cladistic analysis provides a structured view of how different programming solutions relate to one another, tracing back to their origins in terms of conceptual and practical applications.

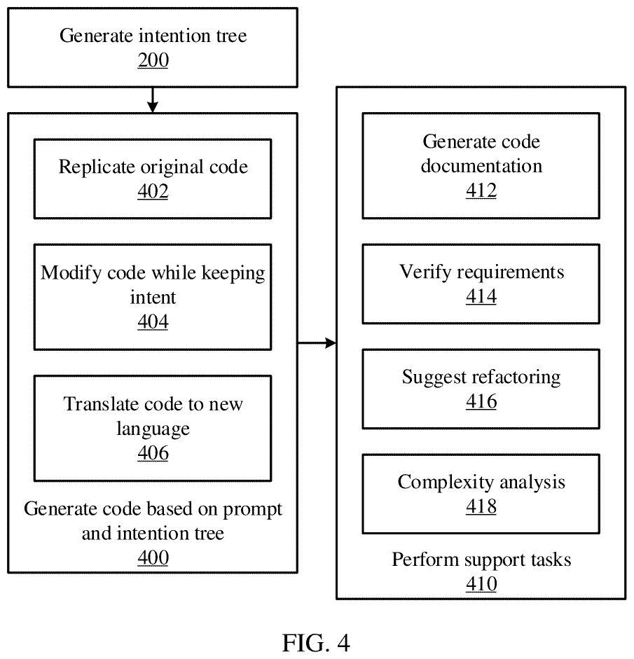

Referring now to FIG. 4, the use of the intention tree for code generation is shown. Block 200 generates the intention tree 108 for a given code base, as described above. Block 400 then uses the LLM 104 to generate program code 106 using the intention tree 108, responsive to a query 102. Block 410 performs any of a variety of support tasks.

Examples of uses for the intention tree in the context of code generation 400 include replication 402 of the original code, modifying 404 the original code while keeping to its intent, and translating 406 the original code from original programming into a new programming language. Given the intention tree in block 402, an LLM 104 can produce an exact replica of the original code. In addition, block 404 can produce improvements on the original code, for example providing more readable code that replicates the original intent. This gives granularity on how much code should be replicated or recreated. The higher-level the intention tree, the more freedom the LLM 104 has in improvising. When translating original code to a new programming language in block 406, the structured intent tree helps a translation model to perform the translation without bilingual training between the two programming languages. Smaller models, tuned on the intention trees in each language, can independently interpret and generate translated code, solving challenges in low-resource language pairs.

Various types of analysis and support tasks can be performed in block 410. For example, block 412 can automatically generate documentation for the program code based on the intention tree. Block 414 can perform requirement verification by matching the extracted intentions to a set of requirements for the program code, for example bridging the gap between abstract requirements and code implementation. Block 416 can perform code refactoring, providing proposals for changes to the original program code. Block 418 can perform a complexity analysis, giving a semantic-level complexity measurement by measuring intent branching, depth, and overlaps within the tree. Other types of support activity may include inferring intention from undocumented or legacy program code and reverse engineering the requirements behind that code. Code attribution can be deduced by mapping original documents and the architecture can be evaluated for how well it corresponds to design documents.

In an exemplary embodiment, the intention tree may be used to aid in refactoring code. For example, the code may be refactored to reduce redundancy. The nodes of the cladogram may be clustered according to identify similar intentions. This may include conversion of the intention descriptions into embedded vectors and performing hierarchical clustering using, e.g., k-means clustering. Similar intentions may then be merged, identifying the minimal number of code components needed to achieve the same goals. The redundant code paths can then be removed.

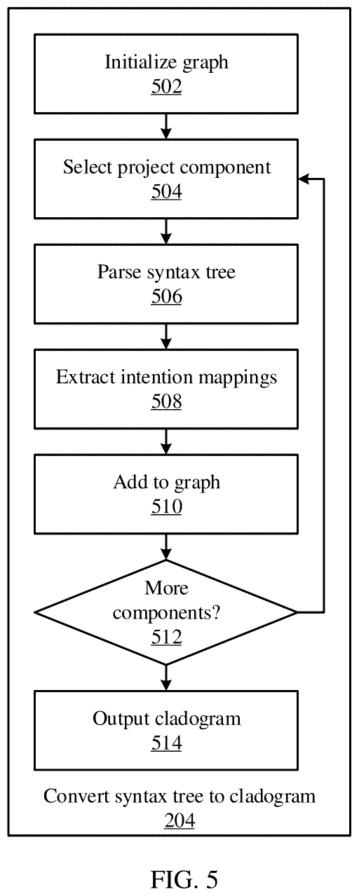

Referring now to FIG. 5, additional detail is shown on the conversion of a syntax tree to a cladogram. Block 502 initializes a cladogram graph G(V, E), where the nodes V include syntax nodes V_{syn} and intention nodes Vᵢₙₜ. The edges E between the nodes V include edges E_{syn-int}, which map between syntax nodes and intention nodes, edges Eᵢₙₜ, which link related intentions across languages, and edges E_{syn}, which link code changes over time.

Block 504 selects a new project component. For example, this component may be a function or class from a given set of program code. Block 506 parses the syntax tree for the selected project component, adding nodes from its syntax tree to the cladogram graph in block 510. Block 508 extracts intention mappings for the syntax nodes, for example querying an LLM to provide an explanation for each. The intention mappings may include a line-by-line description of the function/purpose of the selected component, with edges between the intention and the respective piece of code being added to the graph by block 510. In some cases the intention mappings may further identify similar intentions across different program components, for example linking together the intention for similar code in different languages.

Block 512 determines whether there are more project components to be added. If so, processing returns to block 504 to select a next project component. In some cases the next project component may be a previous or later version of a project component that has already been added to the graph, in which case edges E_{syn} may further be added between the different versions. Once all of the components of the project have been added to the graph, block 514 outputs the completed cladogram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as cladogram generation and analysis 619. In addition to block 200, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

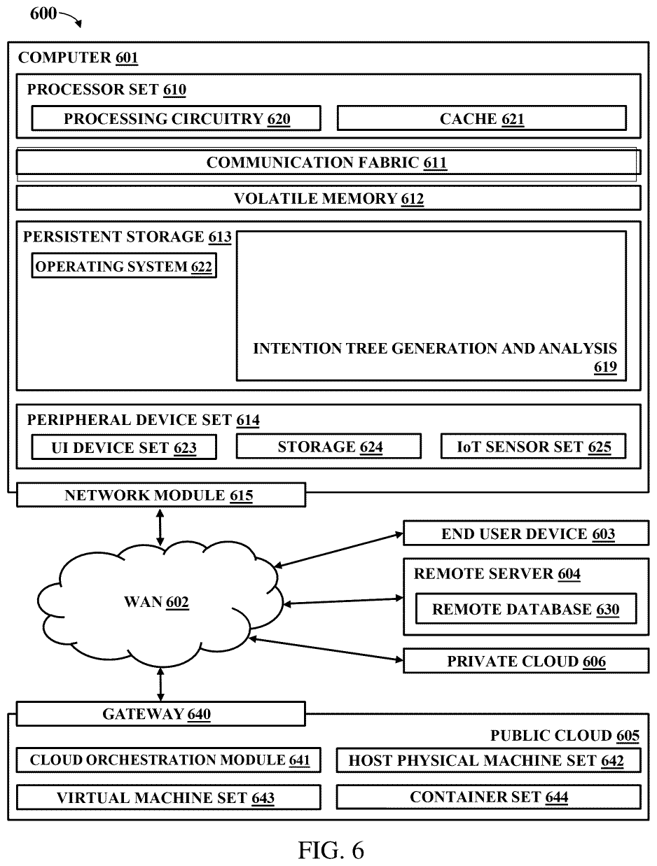

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615. WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

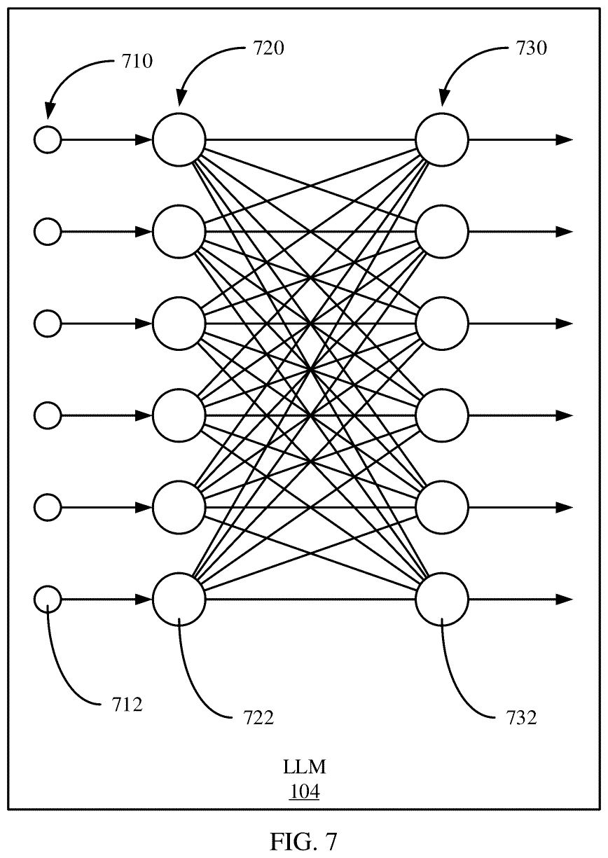

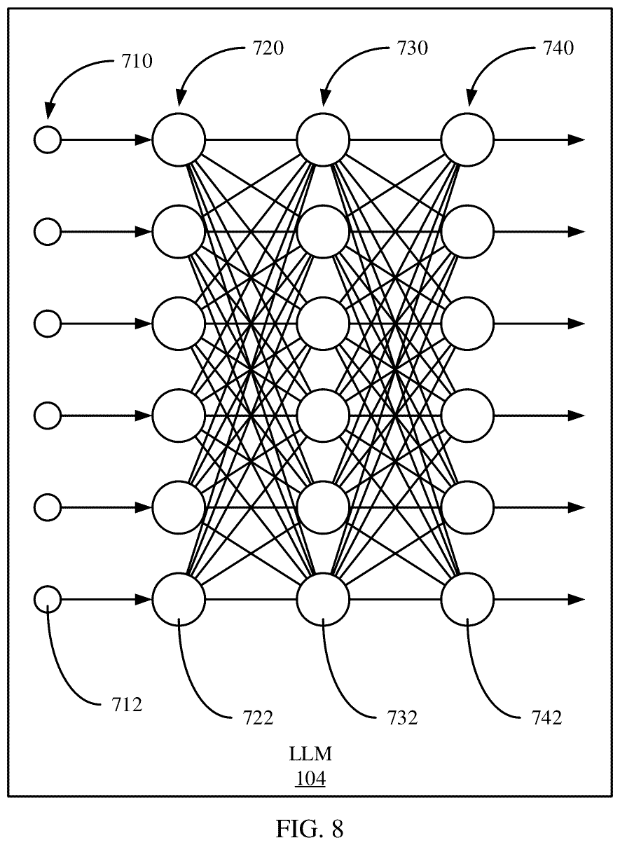

Referring now to FIGS. 7 and 8, exemplary neural network architectures are shown, which may be used to implement parts of the present models, such as LLM 104. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of code generation with intention trees (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for code generation, comprising:
generating a syntax tree from an original code base to represent syntactical information of the original code base;
converting the syntax tree to a cladogram;
generating an intention tree using the cladogram to represent the syntactical information associated with intention statements that describe an intention associated with portions of the original code base; and
generating code in accordance with the intention tree.

2. The method of claim 1, wherein generating the intention tree includes intention statements at a per-line granularity.

3. The method of claim 1, wherein generating the intention tree includes intention statements at a per-function granularity.

4. The method of claim 1, wherein generating the intention tree includes adding syntax nodes that represent code from the original code base and intention nodes that represent intentions of the syntax nodes, with edges between the intention nodes and respective syntax nodes.

5. The method of claim 4, wherein the original code base includes multiple versions of a given program component.

6. The method of claim 5, further comprising adding edges between nodes corresponding to the multiple versions in the intention tree.

7. The method of claim 4, further comprising adding edges between nodes describing similar intentions in the intention tree.

8. The method of claim 1, wherein generating the code includes refactoring the original code base to remove redundancy.

9. The method of claim 1, further comprising clustering nodes of the intention tree with similar intentions to identify redundant code.

10. The method of claim 1, wherein generating the intention tree includes querying a large language model to generate the intention statements for respective portions of the original code base.

11. A computer program product, comprising:
one or more computer-readable storage media; and
program instructions stored on the one or more computer-readable storage media to perform operations comprising:
generating a syntax tree from an original code base to represent syntactical information of the original code base;
converting the syntax tree to a cladogram;
generating an intention tree using the cladogram to represent the syntactical information associated with intention statements that describe an intention associated with portions of the original code base; and
generating code in accordance with the intention tree.

12. A computer system, comprising:
a processor set;
one or more computer-readable storage media; and
program instructions stored on the one or more computer-readable storage media to cause the processor set to perform operations comprising:
generating a syntax tree from an original code base to represent syntactical information of the original code base;
converting the syntax tree to a cladogram;
generating an intention tree using the cladogram to represent the syntactical information associated with intention statements that describe an intention associated with portions of the original code base; and
generating code in accordance with the intention tree.

13. The computer system of claim 12, wherein generating the intention tree includes intention statements at a per-line granularity.

14. The computer system of claim 12, wherein generating the intention tree includes intention statements at a per-function granularity.

15. The computer system of claim 12, wherein generating the intention tree includes adding syntax nodes that represent code from the original code base and intention nodes that represent intentions of the syntax nodes, with edges between the intention nodes and respective syntax nodes.

16. The computer system of claim 15, wherein the original code base includes multiple versions of a given program component.

17. The computer system of claim 16, further comprising adding edges between nodes corresponding to the multiple versions in the intention tree.

18. The computer system of claim 15, further comprising adding edges between nodes describing similar intentions in the intention tree.

19. The computer system of claim 12, wherein generating the code includes refactoring the original code base to remove redundancy.

20. The computer system of claim 12, further comprising clustering nodes of the intention tree with similar intentions to identify redundant code.
